(19) United States
(12) Patent Application Publication
(10) Pub. No.: US 2021/0184307 A1
(43) Pub. Date: Jun. 17, 2021

(54) BATTERY MODULE

(71) Applicant: Samsung SDI Co., Ltd., Yongin-si (KR)

(72) Inventors: Jeong Nam KIM, Yongin-Si (KR); Hyun Jae KIM, Yongin-si (KR); Jang Yeong IM, Yongin-si (KR); Cheorl Hwan KIM, Yongin-si (KR); Pil Yong MOON, Yongin-si (KR); Jong Bong HA, Yongin-si (KR)

(21) Appl. No.: 17/119,610

(22) Filed: Dec. 11, 2020

(30) Foreign Application Priority Data
Dec. 17, 2019 (KR) 10-2019-0169021

(51) Int. Cl. H01M 50/291; H01M 50/209; H01M 50/293

(52) U.S. Cl. CPC H01M 50/291; H01M 50/293; H01M 50/209

(57) ABSTRACT

A battery module includes battery cells arranged along a longitudinal direction of the battery module with respective long side surfaces of adjacent ones of the battery cells facing each other and heat-insulating partition walls interposed between the respective long side surfaces of the adjacent ones of the battery cells. A heat-insulating partition wall of the heat-insulating partition walls includes a heat-insulating sheet and a frame around an edge of the heat-insulating sheet. The heat-insulating sheet has a plate shape and comprises pores therein. The heat-insulating sheet is coupled between the respective long side surfaces of the adjacent ones of the battery cells.

### CROSS-REFERENCE TO RELATED APPLICATION

This application claims priory to and the benefit of Korean Patent Application No. 10-2019-0169021, filed on Dec. 17, 2019, in the Korean Intellectual Property Office (KIPO), the entire disclosure of which is incorporated by reference herein.

### BACKGROUND

### 1. Field

One or more aspects of embodiments of the present disclosure relate to a battery module.

### 2. Description of the Related Art

Generally, an electronic device such as a laptop computer, a mini laptop computer, a netbook, a mobile computer, an ultra-mobile personal computer (UMPC), or a portable multimedia player (PMP) uses a battery pack, which is configured such that a plurality of battery cells are connected to each other in series and/or in parallel, as a portable power source.

In recent years, in order to prevent or reduce environmental contamination (e.g., via vehicle emissions), interest in electric vehicles and electric hybrid vehicles has increased. Accordingly, a battery module having a number of battery cells generally connected in series may be applied to a vehicle. In the battery module, a spacing gap between the battery cells may be increased so as to reduce the influence of swelling of the battery cells, which is caused while the battery cells are repeatedly charged and discharged. Increasing the spacing gap may decrease heat-insulating performance between the battery cells or excessively increase the size of the battery module.

The above information disclosed in this Background Art is only for enhancement of understanding of the background of the described technology, and therefore it may contain information that is not described in the related art.

### SUMMARY

An aspect of one or more embodiments of the present disclosure is directed towards a battery module, in which a heat-insulating sheet of a heat-insulating partition wall has pores (e.g., many pores) and is made of a material having a high restoring force and a high compression rate to improve a heat-insulating and a cooling efficiency of battery cells without being influenced by swelling of the battery cells.

According to one or more embodiments, a battery module includes: battery cells arranged along a longitudinal direction of the battery module with respective long side surfaces of adjacent ones of the battery cells facing each other; and heat-insulating partition walls interposed between the respective long side surfaces of the adjacent ones of the battery cells, wherein a heat-insulating partition wall of the heat-insulating partition walls comprises a heat-insulating sheet and a frame around an edge of the heat-insulating sheet, the heat-insulating sheet having a plate shape and including pores therein, and wherein the heat-insulating sheet is coupled between the respective long side surfaces of the adjacent ones of the battery cells.

The heat-insulating sheet may be made of a ceramic paper or a foam sheet.

The heat-insulating sheet may further include aerogel or an oxide, the oxide being SiO₂, Al₂O₃, ZrO, CaO, MgO, or TiO₂.

The heat-insulating sheet may further include a fiber to connect the aerogel or the oxide.

The frame may be made of a metal or plastic.

A first surface of the heat-insulating sheet and a second surface of the heat-insulating sheet opposite to the first surface may be in contact with the respective long side surfaces of the adjacent ones of the battery cells.

The frame may include a first area horizontally extending from the edge of the heat-insulating sheet and a second area protruding from an end of the first area towards both of the adjacent ones of the battery cells, and wherein the second area may be greater in thickness than the first area.

The heat-insulating partition wall may include a first surface, a second surface opposite to the first surface, and a recess area at the first surface or the second surface due to a protrusion of the second area of the frame, and wherein a partial area of one of the adjacent ones of the battery cells that is adjacent to one of the long side surfaces of the one of the adjacent ones of the battery cells may be in the recess area.

The frame may include a protrusion protruding from the first area towards one of the adjacent ones of the battery cells, and wherein the protrusion may be in contact with one of the long side surfaces of the one of the adjacent ones of the battery cells.

The first surface of the heat-insulating partition wall may be spaced from the one of the long side surfaces of the one of the adjacent ones of the battery cells to provide an air flow path.

The heat-insulating sheet is the ceramic paper and has a compression rate of about 46.9% to about 83% in response to a pressure of about 1.5 kN to about 40 kN applied between first and second surfaces of the heat-insulating sheet.

The heat-insulating sheet is the foam sheet and has a compression rate of about 7.9% to about 65.1% in response to a pressure of about 1.5 kN to about 40 kN applied between first and second surfaces of the heat-insulating sheet.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIGS. 1A and 1B are a perspective view and an exploded perspective view of a battery module according to an embodiment, respectively;

FIG. 2 is a partially longitudinal cross-sectional view of the battery module, taken along the line 2-2 of FIG. 1A;

FIG. 3 is a cross-sectional view illustrating a battery cell of the battery module, taken along the line 3-3 of FIG. 1A;

FIGS. 4A-4C are a perspective view, an exploded perspective view, and a cross-sectional view of a battery module according to another embodiment, respectively; and

FIGS. 5A-5C are an exploded perspective view and a cross-sectional view of a battery module according to another embodiment, respectively

### DETAILED DESCRIPTION

Hereinafter, embodiments of the present disclosure will be described in more detail with reference to the accompanying drawings.

The present disclosure may, however, be embodied in many different forms and should not be construed as being limited to the embodiments set forth herein; rather, these embodiments are provided so that those skilled in the art thoroughly understand the present disclosure. In other words, these embodiments are provided so that this disclosure will be thorough and complete, and will fully convey the scope of the present disclosure to those skilled in the art.

Also, in the drawing figures, the dimensions of layers and regions may be exaggerated for clarity of illustration. Like reference numerals refer to like elements throughout. As used herein, the term “and/or” includes any and all combinations of one or more of the associated listed items. In this specification, it will also be understood that when a member A is referred to as being “on,” “coupled to,” or “connected to” a member B, the member A can be “directly on,” “directly coupled to,” or “directly connected to” the member B or “indirectly on,” “indirectly coupled to,” or “indirectly connected to” the member B with a member B therebetween. When an element is referred to as being “directly on,” “directly coupled to,” or “directly connected to” another element, there are no intervening elements present. The terms used herein are for illustrative purposes of the present disclosure only and should not be construed to limit the meaning or the scope of the present disclosure.

As used in this specification, a singular form may, unless definitely indicating a particular case in terms of the context, include a plural form. For example, the singular forms “a,” “an,” and “the” are intended to include the plural forms as well, unless the context clearly indicates otherwise. Also, the expressions “includes,” “including,” “comprises,” and/or “comprising,” used in this specification specify the presence of the mentioned shapes, numbers, steps, operations, members, elements, components, and/or groups thereof, but do not preclude the presence or addition of one or more other shapes, numbers, steps, operations, members, elements, components, and/or groups thereof.

As used herein, expressions such as “at least one of,” “one of,” and “selected from,” when preceding a list of elements, modify the entire list of elements and do not modify the individual elements of the list.

Further, the use of “may” when describing embodiments of the present disclosure refers to “one or more embodiments of the present disclosure”.

As used herein, terms such as “first,” “second,” etc. are used to describe various members, components, regions, layers, and/or portions. However, it is obvious that the members, components, regions, layers, and/or portions should not be defined by these terms. The terms do not refer to a particular order, up and down, or superiority, and are used only for distinguishing one member, component, region, layer, or portion from another member, component, region, layer, or portion. Thus, a first member, component, region, layer, or portion which will be described may also refer to a second member, component, region, layer, or portion, without departing from the teaching of the present disclosure.

Spatially relative terms, such as “below”, “beneath”, “lower”, “above”, “upper” and the like, used herein for ease of description to describe one element or feature's relationship to another element(s) or feature(s) as illustrated in the figures. These spatially relative terms are intended for easy comprehension of the present disclosure according to various process states or usage states of the present disclosure, and thus, the present disclosure is not limited thereto. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

As used herein, the terms “substantially,” “about,” and similar terms are used as terms of approximation and not as terms of degree, and are intended to account for the inherent deviations in measured or calculated values that would be recognized by those of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

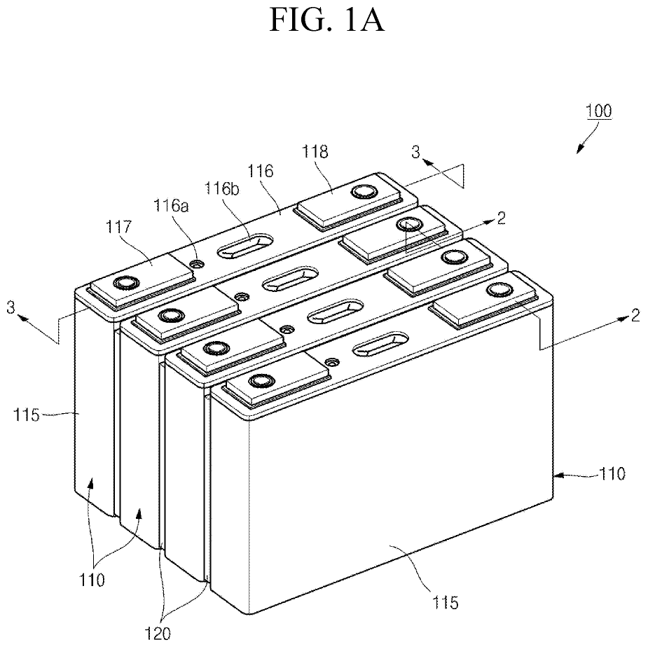

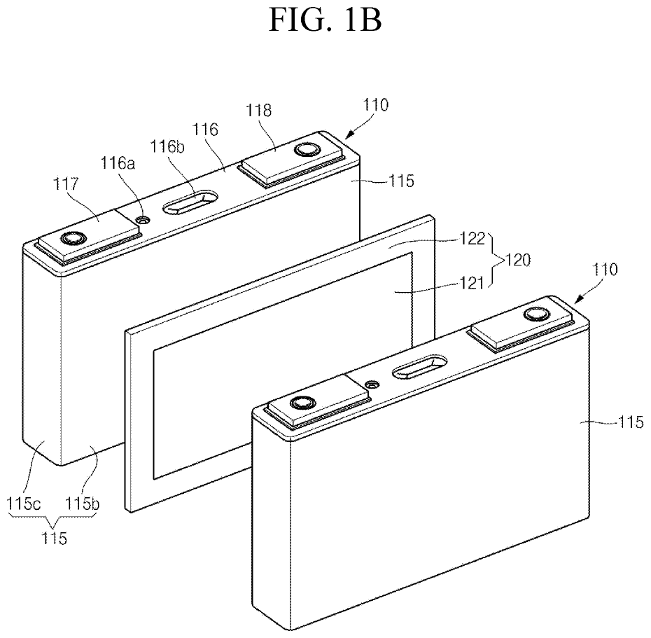

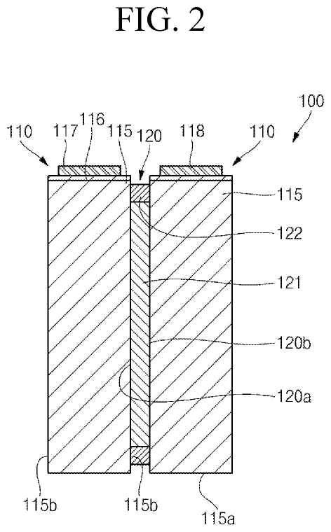

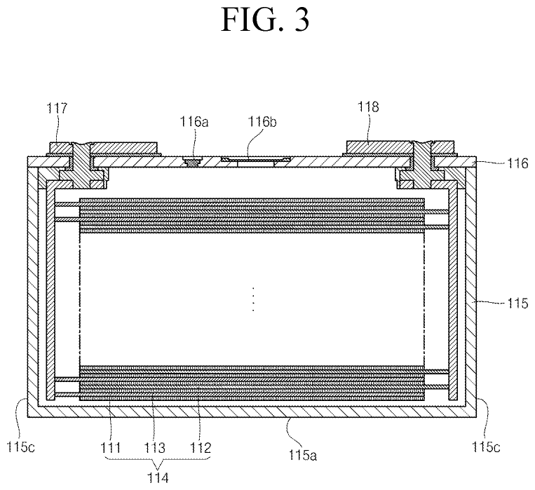

FIG. 1A is a perspective view of a battery module according to an embodiment, and FIG. 1B is a partially exploded perspective view illustrating a portion of the battery module of FIG. 1A. In addition, FIG. 2 is a partially longitudinal cross-sectional view of the battery module, taken along the line 2-2 of FIG. 1A, and FIG. 3 is a cross-sectional view of a battery cell, taken along the line 3-3 of FIG. 1A. Hereinafter, the battery module 100 will be described in more detail with reference to FIGS. 1A, 1B, 2, and 3.

As illustrated in FIGS. 1A, 1B, 2, and 3, the battery module 100 may include a plurality of battery cells 110 and a plurality of heat-insulating partition walls 120. Furthermore, the plurality of battery cells 110 and the plurality of heat-insulating partition walls 120 may be disposed to alternate with each other. For example, each of the plurality of heat-insulating partition walls 120 may be between two adjacent ones of the plurality of battery cells 110. The battery module 100, in which the plurality of battery cells 110 and the plurality of heat-insulating partition walls 120 are sequentially stacked alternately along one side direction thereof, may be further provided with end plates for fixing the plurality of battery cells 110 and the plurality of heat-insulating partition walls 120 at both ends thereof.

The battery cell 110 includes an electrode assembly 114, which is constituted by a positive electrode plate 111, a negative electrode plate 112, and a separator 113 interposed between the positive electrode plate 111 and the negative electrode plate 112, a case 115 having a space (e.g., an internal volume), in which the electrode assembly is accommodated, a cap plate 116 coupled to the case to seal the case, and positive and negative electrode terminals 117 and 118 connected (e.g., electrically connected) to the positive and negative electrode plates 111 and 112 and protruding towards the outside of the cap plate 116.

The positive electrode plate 111 is provided by applying a positive electrode active material such as a transition metal oxide on a positive electrode collector made of metal foil such as aluminum, and includes a positive electrode non-coating portion, on which the positive electrode active material is not applied. The positive electrode non-coating portion is disposed on a side surface of the positive electrode plate 111 along a longitudinal direction of the positive electrode plate 111 to serve as a passage through which current flows between the positive electrode plate 111 and the positive electrode terminal 117. Here, the positive electrode non-coating portion may protrude towards an upper end (side end—depending the orientation) of the electrode assembly 114, but the protrusion direction of the positive electrode non-coating portion is not limited thereto.

The negative electrode plate 112 is provided by applying a negative electrode active material such as graphite or carbon on a negative electrode collector made of metal foil such as nickel or copper, and includes a negative electrode non-coating portion, on which the negative electrode active material is not applied. The negative electrode non-coating portion is disposed on a side surface of the negative electrode plate 112 along a longitudinal direction of the negative electrode plate 112 to serve as a passage through which current flows between the negative electrode plate 112 and the negative electrode terminal 118. Here, the negative electrode non-coating area may protrude towards an upper (or lower) end (side end—depending the orientation) of the electrode assembly 114, but the protrusion direction of the positive electrode non-coating portion is not limited thereto.

The separator 113 is disposed between the positive electrode plate 111 and the negative electrode plate 112 to function to prevent or substantially prevent a short-circuit and to allow movement of lithium ions. The separator 113 may be made of polyethylene, polypropylene, or a composite film of the polyethylene and the polypropylene. However, the present disclosure is not limited thereto, and the material of the separator 113 may be any suitable material.

In the electrode assembly 114, the positive electrode plate 111, the negative electrode plate 112, and the separator 113 interposed between the positive electrode plate 111 and the negative electrode plate 112 to insulate (e.g., electrically insulate) the positive electrode plate 111 from the negative electrode plate 112 are wound in a jelly-roll shape or stacked.

The case 115 is made of a conductive metal such as aluminum, an aluminum alloy, or nickel-plated steel, and has a substantially hexahedral shape having an opening in which the electrode assembly 114, the positive electrode terminal 117, the negative electrode terminal 118, and an electrolyte are accommodated. The case 115 may include a bottom surface 115a, two long side surfaces 115b extending upward from long sides of the bottom surface 115a, and short side surfaces 115c extending upward from short sides of the bottom surface 115a. Although the opening is not illustrated because the case 115 and the cap plate 116 are illustrated as being coupled to each other, a circumferential portion of the cap plate 116 substantially defines a substantially opened portion of the case 115. An inner surface of the case 115 is insulated to be electrically insulated from the electrode assembly 114, the positive electrode terminal 117, and the negative electrode terminal 118.

The cap plate 116 seals the opening of the case 115, and may be made of the same material as the case 115. In addition, the cap plate 116 may include a safety vent 116b and a plug 116a that blocks an electrolyte injection hole.

The positive electrode terminal 117 is connected (e.g., electrically connected) to the positive electrode plate 111, and protrudes to the outside of the cap plate 116. Also, the negative electrode terminal 118 is connected (e.g., electrically connected) to the negative electrode plate 112, and protrudes to the outside of the cap plate 116.

In addition, the positive electrode terminals 117 and the negative electrode terminals 118 of the plurality of battery cells 110 may be connected (e.g., electrically connected) to adjacent positive electrode terminals 117 and adjacent negative electrode terminals 118 of the battery cells 110 through busbars, respectively. That is, the plurality of battery cells 110 may be connected to each other in series and/or in parallel.

The heat-insulating partition wall 120 has a flat plate shape (e.g., a plate shape in the form of a sheet) and may include a heat-insulating sheet 121 and a frame 122 surrounding (e.g., around) an edge of the heat-insulating sheet 121. Here, the heat-insulating partition wall 120 may have a shape corresponding to one surface of the case 115 of the battery cell 110. Furthermore, one surface of the heat-insulating partition wall 120 may be in contact with a surface (e.g., one surface) of the battery cell 110, and an opposite surface of the heat-insulating partition wall 120, which is opposite to the one surface of the heat-insulating partition wall 120, may be in contact with a surface (e.g., one surface) of another battery cell 110. That is, the heat-insulating partition wall 120 may be interposed between the long side surface 115b of the case 115 of one battery cell 110 and the long side surface 115b of the case 115 of another battery cell 110.

The heat-insulating partition wall 120 may include a first surface 120a and a second surface 120b, which is opposite to the first surface 120a, and each of the first surface 120a and the second surface 120b may have shapes corresponding to that of the long side surface 115b of the battery cell 110. For example, the heat-insulating partition wall 120 may have a rectangular plate shape.

The heat-insulating sheet 121 may have a rectangular plate shape having a plurality of pores therein. In addition, the heat-insulating sheet 121 may be made of an insulation material, which has high heat-insulating performance as well as high restoring force. A ceramic paper or a foam sheet, which has a high porosity, may be used as the heat-insulating sheet 121. However, the present disclosure is not limited thereto. Furthermore, in one or more embodiments, the heat-insulating sheet 121 may further include at least one of aerogel or oxide that has high heat-insulating performance. Here, the oxide having the high heat-insulating performance may include at least one of SiO₂, Al₂O₃, ZrO, CaO, MgO, or TiO₂.

As described above, when the heat-insulating sheet 121 includes aerogel, the porosity may be further increased to improve the heat-insulating performance. In addition, when the heat-insulating sheet 121 includes the oxide having the high heat-insulating performance, the heat-insulating performance may be improved.

Furthermore, the heat-insulating sheet 121 may further include a fiber to connect aerogel or an oxide (e.g., to secure/reinforce the aerogel or the oxide). The heat-insulating sheet 121 may secure more pores through the fiber to improve the heat-insulating performance, the compression rate, and the restoring force of the heat-insulating sheet 121.

Referring to Table. 1, results obtained by measuring the compression rate of the heat-insulating sheet 121 according to a pressure applied on both surfaces of the heat-insulating sheet 121 are shown.

TABLE 1

| kN | 1140F | 1150S | BSFP |
|---|---|---|---|
| 1.5 | 20.8% | 7.9% | 46.9% |
| 5 | 48.6% | 32.4% | 63.6% |
| 10 | 58.1% | 47.0% | 71.5% |
| 15 | 61.4% | 52.4% | 75.4% |
| 20 | 63.1% | 55.0% | 77.9% |
| 25 | 64.2% | 56.7% | 79.7% |
| 30 | 64.7% | 57.8% | 81.1% |
| 35 | 65.0% | 58.5% | 82.2% |
| 40 | 65.1% | 59.1% | 83.0% |

As shown in Table 1, when the heat-insulating sheet 121 is provided as a ceramic paper, such as a bio-soluble fiber paper (BSFP), containing an alkali earth metal, if a pressure of about 1.5 kN to about 40 kN is applied between the first surface 120a and the second surface 120b, the heat-insulating sheet 121 may have a corresponding compression rate of about 46.9% to about 83%. Furthermore, when the heat-insulating sheet 121 is provided as the foam sheets 1140F and 1150S, if a pressure of about 1.5 kN to about 40 kN is applied between the first surface 120a and the second surface 120b, the heat-insulating sheet 121 may have a corresponding compression rate of about 7.9% to about 65.1%.

In one or more embodiments, the heat-insulating sheet 121 may be pressed by a pressure of about 1.5 kN to about 10 kN due to the battery cells 110 which are in contact with both the first and second surfaces 120a and 120b, respectively, and the heat-insulating sheet 121 may be fixed between the battery cells 110. The heat-insulating partition wall 120 may also be additionally compressed by a pressure exceeding about 10 kN due to swelling caused when the battery cells 110 are charged and discharged. As described above, if a battery cell 110 increases in temperature, the heat-insulating sheet 121 may block heat transfer to adjacent battery cells 110. In addition, pores may be provided in the heat-insulating sheet 121 to improve the cooling efficiency of the battery cells 110.

The frame 122 may surround (e.g., be around) at least one side of the heat-insulating sheet 121. As illustrated in FIG. 1B, the frame 122 may be in a rectangular ring shape or a substantially rectangular ring shape, which surrounds four sides of the heat-insulating sheet 121, but the present disclosure is not limited thereto. The frame 122 may be made of a plastic and/or a metal. The compression rate and the restoring force of the frame 122 may be less than the compression rate and the restoring force of the heat-insulating sheet 121. In addition, the frame 122 may have a thickness less than that of the heat-insulating sheet 121. Here, the thickness of the heat-insulating sheet 121 may be (or substantially be) a distance in a direction from the first surface 120a to the second surface 120b, and the thickness of the frame 122 may be a distance in the same direction.

The above-configured heat-insulating partition wall 120 may be pressed and attached or fixed to the long side surface 115b of the battery cell 110 as illustrated in FIG. 2 when the battery module 100 is coupled and fixed by the end plate because the compression rate and the restoring force of heat-insulating partition wall 120 are high, even though the thickness of the heat-insulating sheet 121 increases. Here, the pressed heat-insulating sheet 121 may have the same thickness as the frame 122. In addition, the heat-insulating partition wall 120, which is pressed between and in contact (e.g., close contact) with the battery cells 110, may be fixed between the battery cells 110 without an adhesive (e.g., a separate adhesive). That is, in the battery module 100, the heat-insulating sheet 121 is closely attached and fixed through the pressing while the thickness of the heat-insulating sheet 121 increases to improve the heat-insulating performance and also protect the battery cell 110 against an external impact. In addition, the heat-insulating partition wall 120 may not be influenced by the swelling, which may be caused when the battery cells 110 are charged and discharged, because the restoring force of the heat-insulating partition wall 120 is high.

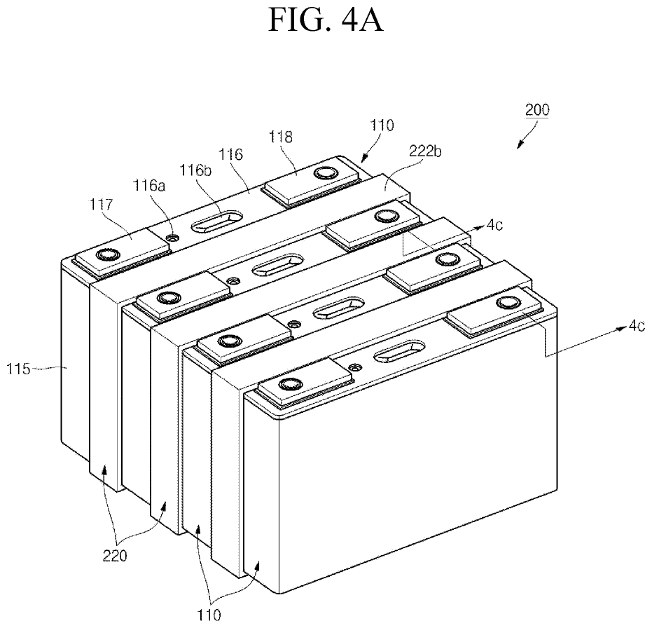

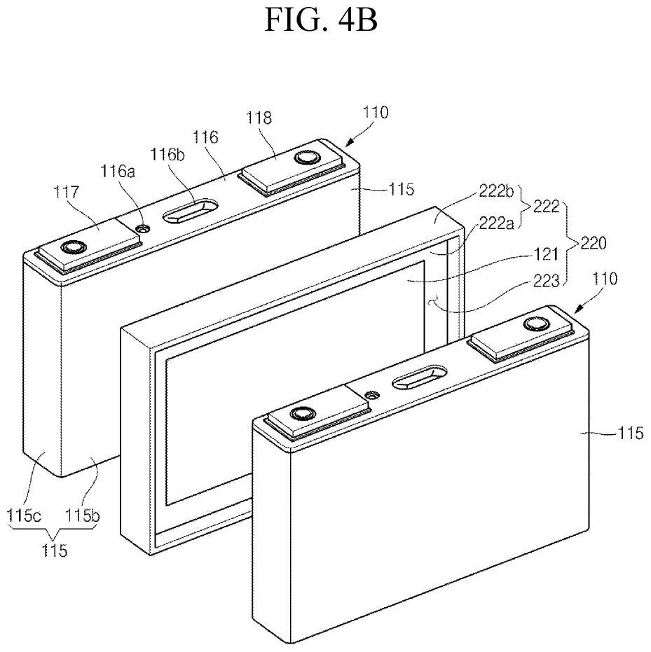

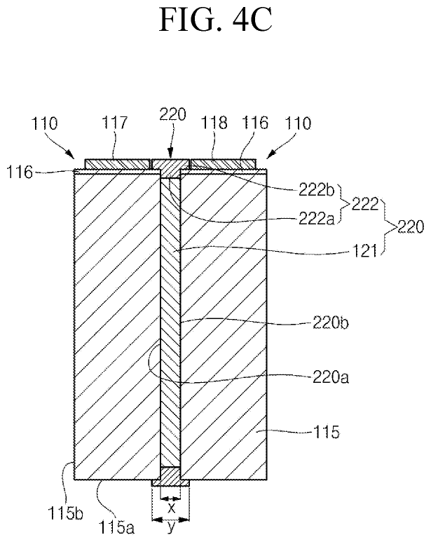

FIG. 4A is a perspective view of a battery module according to another embodiment, FIG. 4B is a partially exploded perspective view illustrating a portion of the battery module of FIG. 4A, and FIG. 4C is a partially longitudinal cross-sectional view of the battery module, taken along the line 4c-4c of FIG. 4A.

As illustrated in FIGS. 4A-4C, a battery module 200 may include a plurality of battery cells 110 and a plurality of heat-insulating partition walls 220. Furthermore, the plurality of battery cells 110 and the plurality of heat-insulating partition walls 220 may be disposed to alternate with each other. For example, each of the plurality of heat-insulating partition walls 220 may be between two adjacent ones of the plurality of battery cells 110. In addition, the battery module 200, in which the plurality of battery cells 110 and the plurality of heat-insulating partition walls 220 are stacked (e.g., sequentially stacked) alternately along one direction, may be further provided with end plates for fixing the plurality of battery cells 110 and the plurality of heat-insulating partition walls 220 at both ends of the battery module 200.

Each of the battery cells 110 of the battery module 200 may be the same as the battery cell 110 of the battery module 100, and a heat-insulating sheet 121 of each of the heat-insulating partition walls 220 may be the same as the heat-insulating sheet 121 of the heat-insulating partition wall 120. The battery cell 110 of the battery module 100 and the heat-insulating sheet 121 of the heat-insulating partition wall 120 are illustrated in FIGS. 1A, 1B, 2, and 3. Hereinafter, a frame 222 of the heat-insulating partition wall 220 of the battery module 200, which is different from the battery module 100, will be described in more detail.

The frame 222 may surround at least one side of the heat-insulating sheet 121. As illustrated in FIG. 4B, the frame 222 may be in a rectangular ring shape or a substantially rectangular ring shape, which surrounds four sides of the heat-insulating sheet 121, but the present disclosure is not limited thereto. In addition, the frame 222 may include a first area 222a horizontally extending from (or to) an edge of the heat-insulating sheet 121, and a second area 222b protruding from an end of the first area 222a towards both of the battery cells 110 (e.g., a portion of the second area 222b protrudes towards one of the battery cells 110 and another portion of the second area 222b protrudes towards another one of the battery cells 110). In one or more embodiments, the first area 222a extends from an edge (e.g., an outer edge) of the heat-insulating sheet 121 in a direction perpendicular to a thickness direction of the heat-insulating sheet 121, and the second area 222b protrudes from an end (e.g., an outer end) of the first area 222a in the thickness direction. Therefore, in the frame 222, a thickness y of the second area 222b may be greater than a thickness x of the first area 222a as illustrated in FIG. 4C. In addition, in the frame 222, the thickness of the first area 222a may be less than that of the heat-insulating sheet 121, and the thickness of the second area 222b may be greater than that of the heat-insulating sheet 121. Further, the compression rate and the restoring force of the frame 222 may be less than those of the heat-insulating sheet 221. The frame 222 may be made of a plastic and/or a metal.

As illustrated in FIGS. 4A-4C, the second area 222b of the frame 222 may be in contact with a short side surface 115c and a bottom surface 115a of the case 115 of the battery cell 110 and a cap plate 116. That is, the second area 222b may surround (or may be around) a partial area of the battery cell 110. The long side surface 115b of the battery cell 110 may be in contact with the first area 222a of the frame 222 and the heat-insulating sheet 121. Here, the heat-insulating partition wall 220 may include a first surface 220a and a second surface 220b opposite to (e.g., facing oppositely away from) the first surface 220a. The first surface 220a and the second surface 220b may be in contact with the long side surfaces 115b of corresponding battery cells 110 (e.g., two adjacent battery cells 110), respectively.

In addition, in the heat-insulating partition wall 220, recess areas (spaces) 223 may be provided in or at the first surface 220a and the second surface 220b due to the second area 222b protruding from the first surface 220a and the second surface 220b towards the battery cell 110. For example, the recess areas 223 may be provided in or at the first surface 220a and the second surface 220b due to the second area 222b protruding away from the first surface 220a and the second surface 220b in the thickness direction of the heat-insulating sheet 121. In addition, a partial area that is adjacent to the long side surface 115b of the battery cells 110 may be inserted into the recess areas (spaces) 223 at both sides of the heat-insulating partition wall 220. That is, the heat-insulating partition wall 220 is provided with the second area 222b, and a partial area of the battery cell 110 may be inserted into and coupled to the heat-insulating partition wall 220 to increase coupling force between the battery cell 110 and the heat-insulating partition wall 220.

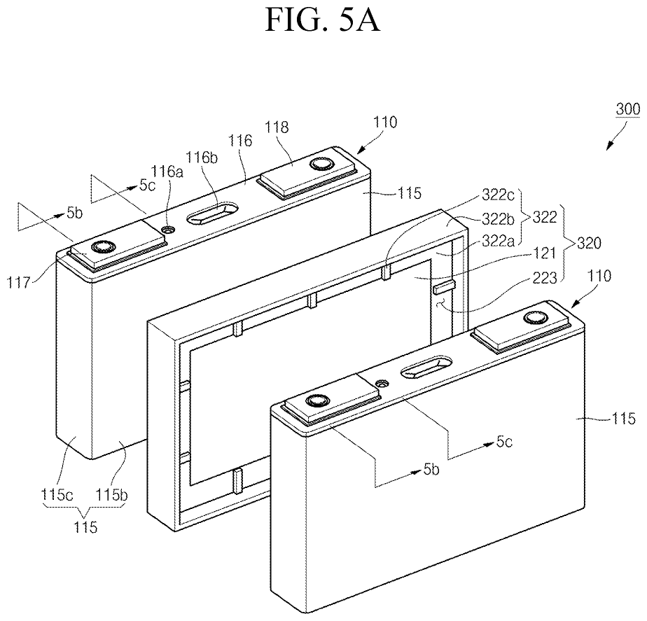

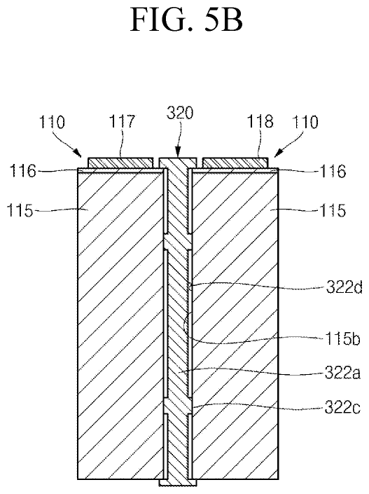

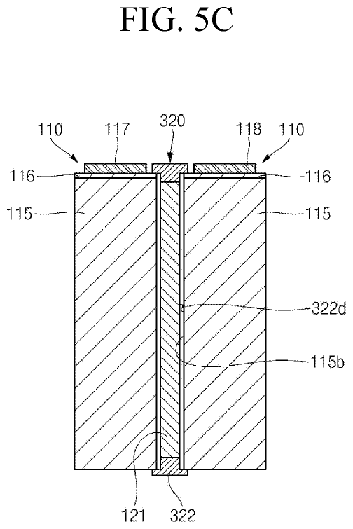

FIG. 5A is a partially exploded perspective view illustrating a battery module according to an embodiment, FIG. 5B is a cross-sectional view taken along the line 5b-5b in a state in which the battery module of FIG. 5A is coupled (e.g., components of the battery module such as the battery cells 110 and heat-insulating partition walls 320 are coupled to each other or fixed by an end plate), and FIG. 5C is a cross-sectional view taken along the line 5c-5c in a state in which the battery module of FIG. 5A is coupled.

Hereinafter, a battery module 300 will be described in more detail with reference to FIGS. 5A-5C.

First, FIG. 5A illustrates one heat-insulating partition wall 320 and two battery cells 110, but the battery module 300 may include a plurality of battery cells 110 and a plurality of heat-insulating partition walls 320 like the battery module 200 illustrated in FIG. 4A. Furthermore, the plurality of battery cells 110 and the plurality of heat-insulating partition walls 320 may be disposed to alternate with each other. For example, each of the plurality of heat-insulating partition walls 320 may be between two adjacent ones of the plurality of battery cells 110. In addition, the battery module 300, in which the plurality of battery cells 110 and the plurality of heat-insulating partition walls 320 are stacked (e.g., sequentially stacked) alternately along one direction, may be further provided with end plates for fixing the plurality of battery cells 110 and the plurality of heat-insulating partition walls 320 at both ends of the battery module 300.

The battery cell 110 of the battery module 300 may be the same as the battery cell 110 of the battery module 100, and a heat-insulating sheet 121 of the heat-insulating partition wall 320 may be the same as the heat-insulating sheet 121 of the heat-insulating partition wall 120. The battery cell 110 of the battery module 100 and the heat-insulating sheet 121 of the heat-insulating partition wall 120 are illustrated in FIGS. 1A, 1B, 2, and 3. Furthermore, a frame 322 of the heat-insulating partition wall 320 of the battery module 300 may be similar to that of the battery module 200 illustrated in FIG. 4A-4C. However, the frame 322 of the heat-insulating partition wall 320 of the battery module 300 may be further provided with a protrusion 322c on a first area 322a. The protrusion 322c may protrude away from the first area 322a and towards the battery cell 110 of the battery module 300.

Hereinafter, a configuration of the protrusion 322c of the frame 322 of the heat-insulating partition wall 320 of the battery module 300, which is different from those of the battery module 100 and the battery module 200, will be described in more detail.

The frame 322 may surround the heat-insulating sheet 121 in a frame form. That is, the frame 322 may be in a rectangular ring shape or a substantially rectangular ring shape. In addition, the frame 322 may include a first area 322a horizontally extending from an edge of the heat-insulating sheet 121, and a second area 322b protruding from an end of the first area 322a towards both of the battery cells 110 (e.g., a portion of the second area 322b protrudes towards one of the battery cells 110 and another portion of the second area 322b protrudes towards another one of the battery cells 110). In one or more embodiments, the first area 322a extends from an edge (e.g., an outer edge) of the heat-insulating sheet 121 in a direction perpendicular to a thickness direction of the heat-insulating sheet 121, and the second area 322b protrudes from an end (e.g., an outer end) of the first area 322a in the thickness direction. In addition, at least one protrusion 322c protruding toward the battery cell 110 may be disposed on the first area 322a. For example, at least one protrusion 322c (e.g., two protrusions 322c) may be disposed on respective areas of the first area 322a (e.g., the first area 322a having the rectangular ring shape) such that the protrusions 322c are symmetrical to each other. For example, the protrusions 322 may be symmetrical to each other on respective upper and lower areas of the first area 322a. However, the present disclosure is not limited thereto. For example, at least one protrusion 322c (e.g., two protrusions 322c) may be disposed on respective areas of the first area 322a (e.g., the first area 322a having the rectangular ring shape) such that the protrusions 322c are symmetrical to each other on respective side areas of the first area 322a. FIG. 5A illustrates a state in which each of the upper area and lower area includes three protrusions 322c, and each of both the side areas includes two protrusions 322c, but the present disclosure is not limited thereto. For example, any suitable number of protrusions may be present on different areas of the first area 322a. In one or more embodiments, each of the protrusions 322c may be aligned with another one of the protrusions 322c, and in other embodiments, the protrusions 322c may be offset (not aligned) with each other.

The heat-insulating partition wall 320 may include the protrusions 322c so as to be spaced a set distance (e.g., a predetermined distance) from the long side surface 115b of the battery cell 110. That is, the long side surfaces 115b of the battery cell 110 may be in contact with the protrusions 322c, and may be spaced apart from or spaced from the first surface 320a and the second surface 320b of the heat-insulating partition wall 320 by a height of each of the protrusions 322c. In addition, the heat-insulating partition wall 320 may be provided with an air flow path 322d between the first surface 320a and the long side surface 115b of the battery cell and between 110 the second surface 320b and the long side surface 115b of the battery cell 110 by the protrusions 322c. That is, the heat-insulating partition wall 320 may include the air flow path 322d to more improve heat-insulating performance.

In the battery module according to the embodiment, the heat-insulating sheet of the heat-insulating partition wall may have many pores and be made of the material having the high restoring force and the high compression rate, and thus the heat-insulating and the cooling efficiency of the battery cells may be improved without being influenced by the swelling of the battery cells.

In addition, in the battery module according to the various embodiments, the compression rate and the restoring force of the heat-insulating sheet may be high compared with those of the frame, and thus the battery cell may be easily fixed by the pressing of the heat-insulating sheet without a separate adhesive component.

The above-described embodiments are merely for showing and describing the present disclosure, and the present disclosure is not limited to the above-described embodiments. It will be understood by those of ordinary skill in the art that various suitable changes or modifications in form and details may be made within the technical spirit of the present disclosure including all ranges of technologies to which the present disclosure pertains without departing from the essence of the present disclosure as claimed in the following claims, and equivalents thereof.

What is claimed is:

1. A battery module comprising:
battery cells arranged along a longitudinal direction of the battery module with respective long side surfaces of adjacent ones of the battery cells facing each other; and
heat-insulating partition walls interposed between the respective long side surfaces of the adjacent ones of the battery cells,
wherein a heat-insulating partition wall of the heat-insulating partition walls comprises a heat-insulating sheet and a frame around an edge of the heat-insulating sheet, the heat-insulating sheet having a plate shape and comprising pores therein, and
wherein the heat-insulating sheet is coupled between the respective long side surfaces of the adjacent ones of the battery cells.

2. The battery module of claim 1, wherein the heat-insulating sheet is made of a ceramic paper or a foam sheet.

3. The battery module of claim 2, wherein the heat-insulating sheet further comprises aerogel or an oxide, the oxide being SiO₂, Al₂O₃, ZrO, CaO, MgO, or TiO₂.

4. The battery module of claim 3, wherein the heat-insulating sheet further comprises a fiber to connect the aerogel or the oxide.

5. The battery module of claim 1, wherein the frame is made of a metal or plastic.

6. The battery module of claim 1, wherein a first surface of the heat-insulating sheet and a second surface of the heat-insulating sheet opposite to the first surface are in contact with the respective long side surfaces of the adjacent ones of the battery cells.

7. The battery module of claim 1, wherein the frame comprises a first area horizontally extending from the edge of the heat-insulating sheet and a second area protruding from an end of the first area towards both of the adjacent ones of the battery cells, and
wherein the second area is greater in thickness than the first area.

8. The battery module of claim 7, wherein the heat-insulating partition wall includes a first surface, a second surface opposite to the first surface, and a recess area at the first surface or the second surface due to a protrusion of the second area of the frame, and
wherein a partial area of one of the adjacent ones of the battery cells that is adjacent to one of the long side surfaces of the one of the adjacent ones of the battery cells is in the recess area.

9. The battery module of claim 7, wherein the frame comprises a protrusion protruding from the first area towards one of the adjacent ones of the battery cells, and
wherein the protrusion is in contact with one of the long side surfaces of the one of the adjacent ones of the battery cells.

10. The battery module of claim 9, wherein a first surface of the heat-insulating partition wall is spaced from the one of the long side surfaces of the one of the adjacent ones of the battery cells to provide an air flow path.

11. The battery module of claim 2, wherein the heat-insulating sheet is the ceramic paper and has a compression rate of about 46.9% to about 83% in response to a pressure of about 1.5 kN to about 40 kN applied between first and second surfaces of the heat-insulating sheet.

12. The battery module of claim 2, wherein the heat-insulating sheet is the foam sheet and has a compression rate of about 7.9% to about 65.1% in response to a pressure of about 1.5 kN to about 40 kN applied between first and second surfaces of the heat-insulating sheet.
